(19) United States
(12) Patent Application Publication
(10) Pub. No.: US 2005/0168783 A1
(43) Pub. Date: Aug. 4, 2005

(54) High resolution image compositing as a solution for digital preservation

(76) Inventor: Spencer Thomas, Ann Arbor, MI (US)

Correspondence Address: Hoffman, Wasson & Gitler, P.C.;Crystal Center 2, Suite 522, 2461 South Clark Street, Arlington, VA, 22202, US

(21) Appl. No.: 11/044,007

(22) Filed: Jan. 28, 2005

Related U.S. Application Data
(60) Provisional application No. 60/539,582, filed on Jan. 29, 2004.

(51) Int. Cl. H04N 1/387; H04N 1/40; H04N 1/41; H04N 1/04; G06K 15/02

(52) U.S. Cl. 358/2.1; 358/1.2; 358/450; 358/462; 358/474; 358/426.14; 358/444; 358/1.16

(57) ABSTRACT

A method and system for archiving printed material including bi-tonal scans as well as halftone images. Each page of the material would be scanned twice. One scan would be used to achieve a bi-tonal image and the second scan would be used to retain the halftone image. These two scans are stored in separate memories and would be “pasted together” to create a total image of the printed page to be viewed on a display screen and delivered in print format to the end user.

### CROSS-REFERENCED APPLICATION

The present application claims the priority of provisional patent application Ser. No. 60/539,582, filed Jan. 29, 2004.

### FIELD OF THE INVENTION

The present invention is directed to the field of scanning printed documents and storing these documents in a manner allowing retrieval by the public.

### BACKGROUND OF THE INVENTION

Currently, printed documents to be preserved in a memory allowing Internet access to these documents are scanned and maintained in an archive. These documents could include, but would not be limited to, academic journals.

These documents were scanned using a 600 DPI (dots per inch) bi-tonal TIFF G4 image format as a long-term digital preservation standard. This provides for clean and crisp text and line-art. Optical Character Recognition (OCR) was used to make content full-text searchable and build an index, and page images are presented to a user in a matter that replicates the experience of reading the original material. For viewing on-screen, grayscale GIF page images at approximately 100 DPI were produced, and the 600 DPI bi-tonal scans in PDF® format for printing was provided.

Early on, it was realized that halftone gray-scale and color images (hereinafter referred to as “halftone images”) needed to be treated separately from the bi-tonal material, since the 600 DPI bi-tonal scan did not reproduce halftones adequately. It was elected to scan such material separately at 200 DPI with 8- or 24-bit depth. This scanning resolution is sufficient to preserve the content of typical halftoned images. These scans were presented to the end-user together with the image of the page upon which the halftone illustration originally appeared but were not imbedded into the page image.

A few years ago an effort was initiated to digitize a collection of academic journals dedicated to Art History and related topics. The significance of the printed halftoned images in these journals exceeded that of the images that had previously been preserved. After some investigation and experimentation, it was decided that these images would be scanned at 300 DPI. The images were presented in the context of the original page, rather than separately as had been done up to this point. To do this, a set of scanning guidelines and data capture specifications were developed that allowed the accurate positioning of the separately scanned illustration on the scanned page image. Software was also developed to compose the separately scanned images together into a single page image for on-screen viewing and for printing using the PDF format.

### SUMMARY OF THE INVENTION

The deficiencies of the prior art are addressed by the present invention which includes a method and system for scanning documents having both bi-tonal material as well halftone images.

Each page of the document to be archived would be scanned to obtain a bi-tonal (black and white) image of the page. If that particular page contained halftone images, it will be scanned a second time, utilizing a different, generally lower resolution. However, it is noted that the resolutions of both the bi-tonal and the halftone image could be equal, as well as the resolution of the bi-tonal image could be lower than the resolution of the halftone image. The bi-tonal image of that page would be stored in a first file and the halftone image of that same page would be stored in a separate, second file. The position of each of the halftone images on that particular page would be stored along with additional information relating to the article in general in a metadata storage file, or, alternatively in either or both of the first and second files. Each additional page of the article would be scanned and stored in a similar manner. Therefore, after all of the pages of the article have been scanned, all of the bi-tonal images would be stored in the first file and all of the halftone images would be stored in the second file. Each of the files can be stored in separate memories, or at different locations of the same memory.

The images provided in both of the files would be delivered to a user for the purpose of reconstructing each page to be displayed on the user's screen or to be printed for later use. Dependent upon whether the user wishes to display the image on his or her screen or to print the image, the manner in which the images would be displayed or printed are slightly different. In the case in which the image is to be displayed upon the user's computer screen, the halftone images would be overlayed upon the bi-tonal image. In the situation in which the page is to be printed, the bi-tonal images provided under the halftone images would be blanked out.

Further features of the invention, its nature and various advantages will be apparent from the accompanying drawing and the following detailed description of the preferred embodiments.

### BRIEF DESCRIPTION OF THE DRAWINGS

FIG. 1 is a block flow diagram showing the method of scanning a page as well as processing the scanned page to be displayed or printed; and

FIG. 2 is a block diagram showing various components of the present invention.

### DETAILED DESCRIPTION OF THE PREFERRED EMBODIMENTS

As previously recited, the present invention is directed to a system and method for scanning and reproducing images on pages which generally contain both bi-tonal images as well as halftone images.

Documents are scanned full pages bi-tonally at generally 600 DPI, while halftone images are scanned with 8 or 24-bit depth at a resolution determined by the source halftone grid, thus 200 DPI for most journals, and 300 DPI for the higher quality images in Art History and related journals, or in a range between 200 DPI and 300 DPI. It is also noted that other resolutions for the bi-tonal and halftone images can be employed. This permits optimized scanning and storage parameters for each type of source material to be developed. It is noted that the exact resolution is not important. It is also noted that, while the bi-tonally image scan generally would have more resolution than the halftone image scan, this is not necessarily the case. For example, both resolutions could be equal, or the halftone image would have more resolution than the bi-tonal image.

Each page thus comprises multiple components that must be composed for display or printing. These components are, on the one hand, the bi-tonal full-page scan and, on the other hand halftone images.

Solutions for on-screen display, and for printing separately, were considered, with the goal of creating an on-screen display that enables the user to easily and quickly view and read individual pages of an article. On-screen viewing should be available to any standard web browser that is capable of displaying images.

The goal for delivering print-quality content is primarily to provide the full scanned image depth and resolution to the printer. Secondarily, the size of the file that is delivered for printing is to be minimized as much as possible.

Modern web browsers support three image formats, GIF, JPEG, and PNG, although PNG support is limited in some versions. All three formats were evaluated for image quality and file size. As a result of these evaluations, it was decided to deliver pages with halftone content in JPEG format with a “quality” parameter setting of 60. Settings higher than 60 increased the file size without any visibly significant change in quality, while settings lower than 60 degraded the text content in particular. Additionally, it was decided to continue to deliver pages with no halftone content in GIF format, because of the smaller file size.

The set of options for print content delivery was smaller than that for on-screen delivery. The frequent use of the PDF format by users meant that composite page images in PDF would definitely need to be delivered. There was no need to decide whether to offer a “no halftone” option for PDF delivery.

Beyond archiving the journal content, a method was determined for facilitating “access,” which can mean many things. At a minimum, it means that the preserved information is retrievable in some form. It also means that the content, as delivered, is as faithful as possible to the original preserved form, while not imposing unreasonable constraints on the end user. Considerations such as dial-up Internet access speeds, disk and RAM requirements, printer memory and speed limitations, display screen sizes, and software availability are taken into account. A significant fraction of the user community has dial-up access to the Internet from home. Since many users have screens between 800 and 1024 pixels wide, it is important to design pages to fit on an 800-pixel wide screen. Some users will be using computers on which they cannot install software, such as those in public “computer labs.” Thus, only common software that is likely to be already installed on those computers, minimally a web browser for on-screen viewing and Adobe Acrobat Reader for printing is all that is necessary.

The following relates to image delivery for the present invention:
GIF page image for text-only pages.
JPEG page image with Q=60 for pages with halftone images.
Page image width of 760 pixels, which fits nicely on an 800-pixel wide screen while maximizing text readability.
Provide an option for the user to view page images created only from the bi-tonal page scan, to reduce download times on slow network connections.
Full-resolution PDF files always include composed Halftone Images. The areas of the bi-tonal page image that lie “behind” the Halftone Images are blanked out when we build the PDF file.
Reduced-resolution PDF files do not include composed halftone images.
PDF image content uses G4 compression for the bi-tonal page image and JPEG compression for the halftone images.

It should be noted that retrieval and the composition of an image can be accomplished at any time such as real-time or just-in-time composition, as well as employing a batch composition.

The implementation of the delivery system for composed images comprises four major parts. These are the image and meta-data storage, software for composing on-screen images, software for composing PDF files, and software to deliver the composed images as part of a web interface.

To save disk space, the bi-tonal page images for each journal article are compressed together into a single file using the Cartesian Perceptual Compression® algorithm. This reduces the space required to about one quarter that required by the original TIFF images. The halftone images are stored as JPEG files, one per image. The set of image files that make up an article in a journal are linked together by the article meta-data. Therefore, it is noted that separate memories are used to store the bi-tonal page images and the Halftone Images.

The article meta-data fully describes the journal article, including information such as the article's title and authors. It also lists the image source files that comprise the article. Each halftone image file is described by its file name and the (x,y) coordinates of a rectangle that it covers in the bi-tonal page image coordinate system. Thus, to build a composed page image or PDF file, the system loads this information from the meta-data and uses it to drive the program or programs that perform the actual composition.

One such program is called JCompose. It takes as input a single bi-tonal page image, a set of halftone images, placement specifications for the halftone images, and parameters that specify the desired output image size and quality. Briefly, it functions as follows:
1. Determine from the scale factor (output image size divided by input image size).
2. Scale the input bi-tonal image.
3. Compute the appropriate scale factor for each halftone image.
4. Compute the position at which the halftone image will be composed into the output.
5. Rescale each halftone image and overlay the result at the computed position in the output image.
6. Compress the output image to a JPEG file using the specified quality parameter.

The bi-tonal image is scaled using an “area averaging” algorithm. Simply put, each output pixel overlays a square region of the input image. Each “black” input pixel whose center lies within this square is considered to contribute to the output gray level. Thus, if all pixels overlapped by the square are black, the output pixel will be black. If only 50% of the pixels overlapped by the square are black, the output pixel will be gray with an intensity of 0.5.

The halftone images are scaled using “bilinear averaging”. That is, each color component in the image is considered as a bilinear “intensity” surface. Again, the output pixel is overlaid onto this surface as a square. The integral of the surface within this square, divided by the area of the square, gives the output intensity of that color component. The scaling algorithms were chosen because they produced good image quality at a reasonable computational cost.

In connection with print content delivery, the program utilized to produce the PDF files is called “page2pdf,” and accepts as input a list of page image files; a list of halftone image files, each accompanied by the page number on which it appears and positioning data; and output file specifications. The procedure it follows for each output page is outlined below:
1. Load the bi-tonal page image.
2. Blank out any bi-tonal page images within the rectangle covered by the halftone image.
3. Add the bi-tonal image to the PDF page.
4. Add each halftone image to the page.

After all the pages have been built, the output PDF file is written. The user also has the ability to view pages without composed images, for a given page or as a preference that changes the default setting for all pages. A given page will be delivered with composed images if the following conditions hold:
1. The journal containing the page is designated as one for which composed pages will be delivered, AND
2. Halftone images exist for the page, AND
3. The user has not selected a preference, OR the user preference is for composed pages, OR the user has asked to view the page in composed form.

A composed image can be produced only when halftone images exist on a page, and position information is available for those images. If no positionable halftone images are associated with a page, then a GIF page image containing only bi-tonal images is delivered.

By default, a composed page image for a page with positional halftone images will be delivered when the journal is marked for composite delivery. The user may elect to view a particular page without the composed halftone images by clicking on a link while viewing the composed page. Users may also set a permanent preference to see pages without composed images. In such case, the user may elect to view any particular page with composed images by clicking on a link while viewing the page.

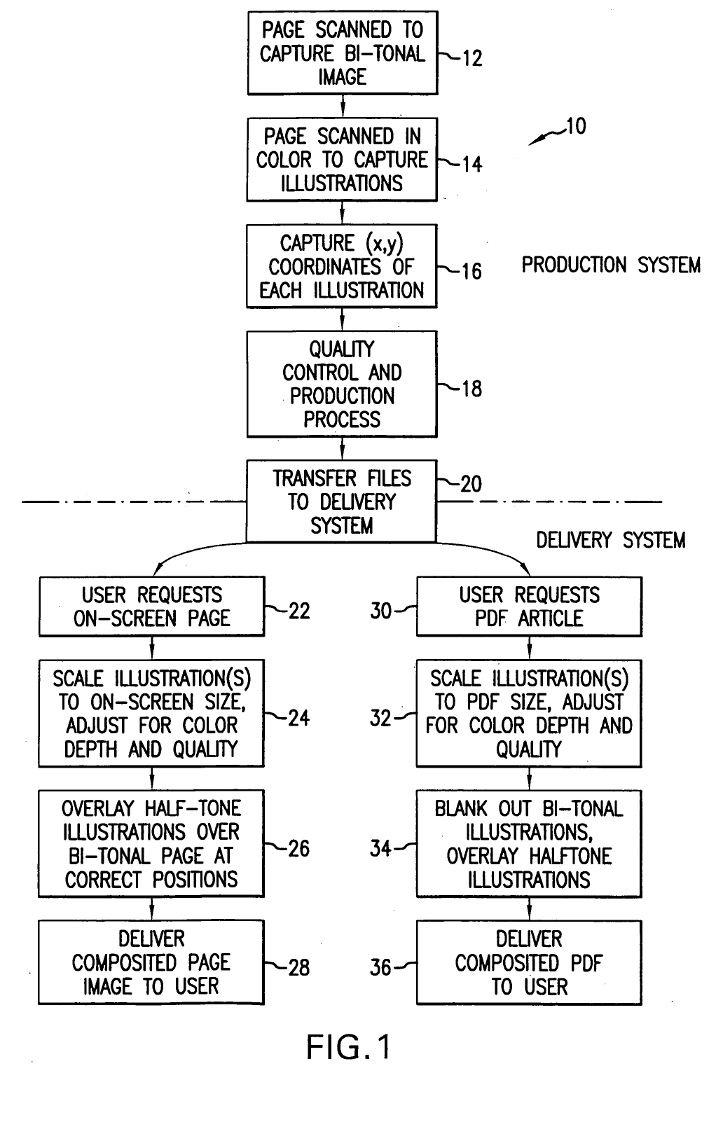

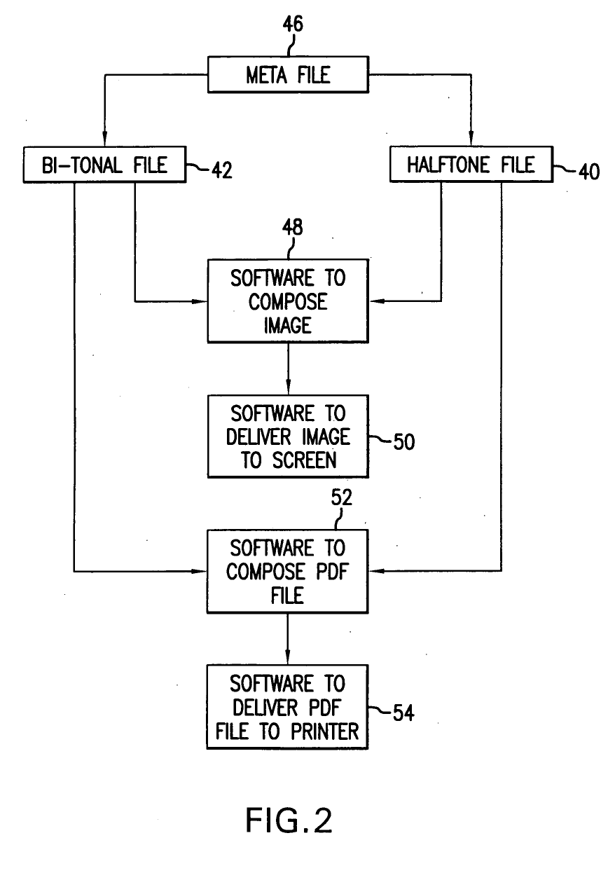

Referring to FIGS. 1 and 2, which illustrates the teachings of the present invention 10, a page of a document or a journal would initially be scanned at 12 to capture a bi-tonal image. This would be true whether the page contains halftone images or not. The resolution of the scan can vary. However, it has been shown that a resolution of 600 DPI would be appropriate. The bi-tonally scanned page would be stored in a bi-tonal file 42 in, for instance, TIFF G4 format. It is noted that the actual formats and compression techniques that are used to produce the bi-tonal image are not essential to the process of the present invention.

Once a bi-tonal scan has been made of a first page, a second scan would be made of that page if that page contains halftone images that need to be captured. It is important to note that the page is not moved on the scan bed after the bi-tonal scan to insure that the scanner registration for the halftone image scan would be identical to that of the bi-tonal image scan. Once this second scan is complete at step 14, the halftone image is stored in a second file 40 employing a TIFF format, using 24-byte color resolution. It is further noted that this second scan is generally made at a resolution different than the resolution of the bi-tonal scan. For example, based upon the type of halftone image as well as the intended user, a resolution of 200 DPI would be used for most journals and 300 DPI would be used for higher quality images.

A combined automated and human process would be utilized to capture the (x,y) coordinates of each of the halftone images at step 16. The automated process attempts to find potential halftone images during the bi-tonal image scan, utilizing a program to capture the halftone image including its (x,y) coordinates. The results of this process are reviewable by humans. These coordinates (the number of pixels, horizontally and vertically from the top-left corner of a page) are measured and are saved in a third file, or metadata memory 46. This metadata describes a relationship between the bi-tonal image and the halftone images. The metadata also includes additional information about the archived document. Although it is shown that the metadata file 46 is separate from the bi-tonal memory 42 and the halftone memory 40, it is noted that this metadata could be provided in either or both of the files 40, 42.

A process of error-checking and data cleansing would be done at step 18 using automated and human efforts. The automated process scans the metadata and images to ensure that there is a consistency of captured information. One technology used in this process would be a random sampling of the images to be printed and viewed. A visual comparison is made of these images, if necessary. This insures that the correct illustrations have been captured and that the (x,y) coordinates of each of the halftone images are correct. This would also insure that the halftone images are scanned correctly and accurately to produce an attractive finished product.

Once this quality control is complete, the material stored in the halftone file 40, and the bi-tonal file 42 are combined in a memory using the information in the metadata file 46 and sent to a delivery system for subsequent use by the end users at step 20. This delivery could encompass physically delivering the material in a particular file format to the end user to be inputted to the hard drive of the user's computer or to deliver the material to the user's computer through the use of the internet. In either situation, the user is supplied with the resulting images. The software 48 to compose the image, software 50 to deliver the image to the user's screen, software to compose a PDF file for printing the image software 54 to deliver PDF file to the printer generally reside on the production side of the system as outlined in the top portion of FIG. 1. However, it is noted that the software could be supplied to the end user.

Referring again to FIG. 1, once the material in the files 40 and 42 is delivered to the end user, the material in these files could either be viewed by the end user and/or printed by the end user. In the situation in which the user wishes to display the images on the computer screen, the user would request an onscreen page at step 22. This onscreen page need not contain illustrations. Even if the onscreen page does contain illustrations, the user has the ability to request only the bi-tonal image to be displayed. In the situation in which the user wishes a composite image consisting of bi-tonal and halftone images, to be displayed on the user's screen, the illustrations would be scaled and adjusted for color depth and resolution. These parameters are determined to provide the best balance between quality and image size to the user. In the situation in which both bi-tonal and halftone images are contained on a particular page, the halftone images are overlayed on top of the bi-tonal page image, replacing the underlying bi-tonal image. This composite page is then delivered to the user at step 28 in various formats such as, but not limited to, GIF, JPEG, or PNG format. This format decision may change over time as new formats become popular or more beneficial.

In the situation that the user wishes a particular page or pages to be printed, the user would request this page or pages to be printed, generally utilizing the PDF format in step 30. Similar to step 24, step 32 would scale the halftone images and adjust these images for color depth and resolution. These parameters are determined for the best balance between quality and image size. At this point, at step 34, the locations of the bi-tonal images are blanked out of the PDF image files to conserve PDF file size. Therefore, the page or pages which are printed would contain both the bi-tonal image as well as the halftone image or images. Due to the aforementioned style of size constrictions, it would make no sense to deliver to the printer a composite page containing halftone images overlaying bi-tonal images. Rather, the page delivered to the printer would blank out the bi-tonal image in the position of the halftone image. At this point, the PDF file would be delivered to the end user at step 36 for printing, using, for example, an Adobe Acrobat reader. Obviously, in the instance that the software to view and print the images reside on the production side, the user must be in communication with the production side to view and print the image on the user's screen or on the user's printer.

While the present invention has been described with reference to its preferred and alternative embodiments, those embodiments are offered by way of example, not by way of limitation. Various additions, deletions, and modifications can be made to the embodiments of the present invention by those skilled in the art without departing from the spirit and scope of the present invention.

1. A method of scanning and storing documents containing bi-tonal and halftone images, comprising the steps of:
a) scanning a first page of the document using a first resolution scan to capture a bi-tonal image;
b) transmitting said bi-tonal image of said first page to a first file;
c) scanning said first page of the document at a second resolution scan;
d) determining the coordinates of each of said halftone images on said first page;
e) transmitting said halftone image of said first page to a second file;
f) transferring said coordinates of each of said halftone images to a memory device; and
g) repeating steps a), b), c), d), e) and f) for each page of the document.

2. The method in accordance with claim 1, including the steps of combining the bi-tonal image data in said first file with the halftone image in said second file to create a composite image including both said bi-tonal image and said halftone image, and transferring said composite image to an end user.

3. The method in accordance with claim 1, wherein said first resolution scan is greater than said second resolution scan.

4. The method in accordance with claim 3, wherein said first resolution scan is 600 DPI.

5. The method in accordance with claim 4, wherein said second resolution scan is between 200 DPI and 300 DPI.

6. The method in accordance with claim 2, further including the steps of:
overlaying said halftone image on at least one of the pages of the document with said bi-tonal image of the same page to create a first composite image; and
displaying said composite image on a display screen.

7. The method in accordance with claim 2, further including the steps of:
blanking out said bi-tonal image on at least one of the pages of the document corresponding to the position of said halftone image of the same page;
positioning said halftone image of said same page at the location or locations of the portion of the page blanked out by said previous step to create a second composite image; and
printing said second composite image.

8. The method in accordance with claim 6, further including the steps of:
blanking out said bi-tonal image on at least one of the pages of the document corresponding to the position of said halftone image of the same page;
positioning said halftone image of said same page at the location or locations of the portion of the page blank out by said previous step to create a second composite image; and
printing said second composite image.

9. The method in accordance with claim 6, further including the step of scaling said halftone image to adjust for display screen size.

10. The method in accordance with claim 7, further including the step of scaling said halftone image to adjust for a PDF format.

11. The method in accordance with claim 6, including the step of utilizing the JPEG format to display said composite images on said display screen.

12. The method in accordance with claim 11, including the step of utilizing a quality index of 60 for said JPEG format.

13. The method in accordance with claim 6, including the step of only displaying said bi-tonal image for a particular page of the document.

14. A system of scanning and storing documents containing bi-tonal and halftone images, comprising:
a scanning device to scan each page of a document;
a first file for storing the bi-tonal image of each of the pages of the document;
a second file for storing the halftone image or images of each of the pages of the document;
a device for combining said bi-tonal images and said halftone image or images of each page of the document to create a composite page of each of the pages of the document.

15. The system in accordance with claim 14, including a display screen for displaying each of said composite pages.

16. The system in accordance with claim 14, further including a printer for printing each of said composite pages.

17. The system in accordance with claim 15, further including a printer for printing each of said composite pages.

18. The system in accordance with claim 14, further including a memory for combining the images in said first file with the images in said second file.
